(19) United States
(12) Patent Application Publication
(10) Pub. No.: US 2022/0386255 A1
(43) Pub. Date: Dec. 1, 2022

(54) Target based Control of Synchronization Signals in D2D Communication

(71) Applicant: Telefonaktiebolaget LM Ericsson (publ), Stockholm (SE)

(72) Inventor: Jose Angel Leon Calvo, Aachen (DE)

(21) Appl. No.: 17/772,300

(22) PCT Filed: Oct. 29, 2019
(86) PCT No.: PCT/EP2019/079537

§ 371 Date: Apr. 27, 2022

(51) Int. Cl. H04W 56/00; H04W 76/14

(52) U.S. Cl. CPC H04W 56/002; H04W 76/14

(57) ABSTRACT

Target based control of synchronization signals in D2D communication A radio device detects (11) at least one first synchronization signal from one or more further radio devices (12, 13). Depending on the at least one detected first synchronization signal, the radio device (11) selects at least one of the one or more further radio devices (12, 13). Further, the radio device (11) transmits a second synchronization signal, excluding the selected at least one further radio device (12) as a transmission target of the second synchronization signal.

### TECHNICAL FIELD

The present invention relates to methods for controlling device-to-device (D2D) communication and to corresponding devices, systems, and computer programs.

### BACKGROUND

Current wireless communication networks, e.g., based on the LTE (Long Term Evolution) or NR technology as specified by 3GPP, also support D2D communication modes to enable direct communication between UEs (user equipments), sometimes also referred to as sidelink communication. Such D2D communication modes may for example be used for vehicle communications, e.g., including communication between vehicles, between vehicles and roadside communication infrastructure and, possibly, between vehicles and cellular networks. Due to wide range of different types of devices that might be involved in the communication with the vehicles, vehicle-to-everything (V2X) communication is another term used to refer to this class of communication. Vehicle communications have the potential to increase traffic safety, reduce energy consumption and enable new services related to intelligent transportation systems.

Due to the nature of the basic road safety services, LTE V2X functionalities have been designed for broadcast transmissions, i.e., for transmissions where all receivers within a certain range of a transmitter are may receive a message from the transmitter, i.e., may be regarded as intended recipients. In fact, the transmitter may not be aware or otherwise be able to control the group of intended receivers. V2X functionalities for the NR technology are for example described in 3GPP TR 38.885 V16.0.0 (2019-03). In the NR technology, also more targeted V2X services are considered, by supporting also groupcast, multicast, or unicast transmissions, in which the intended receiver of a message consists of only a subset of the receivers within a certain range of the transmitter (groupcast) or of a single receiver (unicast). For example, in a platooning service for vehicles there may be certain messages that are only of interest for a member vehicle of the platoon, so that the member vehicles of the platoon can be efficiently targeted by a groupcast transmission. In another example, the see-through functionality, where a one vehicle provides video data from a front facing camera to a following vehicle, may involve V2X communication of only a pair of vehicles, for which unicast transmissions may be a preferred choice.

In D2D communication, synchronization of UEs may be used for establishing D2D communication or for enhancing performance of D2D communication. The synchronization typically involves providing synchronization information to a UE. For example, in a sidelink discovery procedure of the LTE technology, the synchronization information may include a Sidelink Synchronization Signal (SLSS), timing information, and/or some additional configuration parameters, e.g., a MasterinformationBlock-SL message or MasterinformationBlock-SL-V2X message. In the NR technology the synchronization information may include an Sidelink Synchronization Signal Block (S-SSB). In each case, the synchronization information is transmitted in a broadcast mode. The synchronization information transmitted by a UE may be derived from information or signals received from the network while the UE is within network coverage, received from another UE acting as synchronization reference, or received from a Global Navigation Satellite System (GNSS). A UE acting as a synchronization reference may also be referred to as SyncRef UE.

Due to transmitting the synchronization information in a broadcast mode, interference may be caused by the UEs transmitting the interference to every other UE in range. Further, the broadcast transmission of the synchronization information may also result in excessive energy consumption.

Accordingly, there is a need for techniques which allow for efficiently controlling transmission of synchronization information in D2D communication scenarios.

### SUMMARY

According to an embodiment, a method of controlling device-to-device communication is provided. According to the method, a radio device detects at least one first synchronization signal from one or more further radio devices. Depending on the at least one detected first synchronization signal, the radio device selects at least one of the one or more further radio devices. Further, the radio device transmits a second synchronization signal, excluding the selected at least one further radio device as a transmission target of the second synchronization signal.

According to a further embodiment, a radio device is provided. The radio device is configured to detect at least one first synchronization signal from one or more further radio devices. Further, the radio device is configured to, depending on the at least one detected first synchronization signal, select at least one of the one or more further radio devices. Further, the radio device is configured to transmit a second synchronization signal, excluding the selected at least one further radio device as a transmission target of the second synchronization signal.

According to a further embodiment, a radio device is provided. The radio device comprises at least one processor and a memory. The memory contains instructions executable by said at least one processor, whereby the radio device is operative to detect at least one first synchronization signal from one or more further radio devices. Further, the memory contains instructions executable by said at least one processor, whereby the radio device is operative to, depending on the at least one detected first synchronization signal, select at least one of the one or more further radio devices. Further, the memory contains instructions executable by said at least one processor, whereby the radio device is operative to transmit a second synchronization signal, excluding the selected at least one further radio device as a transmission target of the second synchronization signal.

According to a further embodiment of the invention, a computer program or computer program product is provided, e.g., in the form of a non-transitory storage medium, which comprises program code to be executed by at least one processor of a radio device. Execution of the program code causes the radio device to detect at least one first synchronization signal from one or more further radio devices. Further, execution of the program code causes the radio device to, depending on the at least one detected first synchronization signal, select at least one of the one or more further radio devices. Further, execution of the program code causes the radio device to transmit a second synchronization signal, excluding the selected at least one further radio device as a transmission target of the second synchronization signal.

Details of such embodiments and further embodiments will be apparent from the following detailed description of embodiments.

### BRIEF DESCRIPTION OF THE DRAWINGS

FIG. 1 schematically illustrates an exemplary V2X scenario in which D2D communication may be controlled according to an embodiment of the invention.

FIG. 2 schematically illustrates an exemplary scenario according to an embodiment of the invention, in which D2D communication may be controlled according to an embodiment of the invention.

FIG. 3 schematically illustrates selection of a beam for transmission of a synchronization signal in an embodiment of the invention.

FIG. 4 shows a flowchart for schematically illustrating a method according to an embodiment of the invention.

FIG. 5 shows an example of processes according to an embodiment of the invention.

FIG. 6 shows a flowchart for schematically illustrating a method performed by a radio device operating according to an embodiment of the invention.

FIG. 7 shows an exemplary block diagram for illustrating functionalities of a radio device implementing functionalities corresponding to the method of FIG. 5.

FIG. 8 schematically illustrates structures of a radio device according to an embodiment of the invention.

### DETAILED DESCRIPTION OF EMBODIMENTS

In the following, concepts in accordance with exemplary embodiments of the invention will be explained in more detail and with reference to the accompanying drawings. The illustrated embodiments relate to controlling of D2D communication between radio devices. These radio devices may include various types of UEs. The D2D communication may for example be based on the LTE radio technology or the NR radio technology as specified by 3GPP (3^{rd} Generation Partnership Project). However, it is noted that the illustrated concepts could also be applied to other radio technologies, e.g., a WLAN (Wireless Local Area Network) technology.

In the illustrated concepts, certain radio devices may be excluded as transmission target of a synchronization signal. In particular, a beamforming mechanism may be used to control beamforming in such a way that the synchronization signal is not transmitted towards the excluded radio devices. In this way, it can be avoided that the synchronization signal causes interference at the excluded radio devices. The selection of the radio devices to be excluded is performed on the basis of synchronization signals received from these radio devices. Accordingly, an initial exchange of synchronization signals between one or more radio devices may be used as a basis for controlling beamforming for later transmissions of synchronization signals by the radio devices. In these later transmissions, some of the radio devices may be excluded as transmission targets. Specifically, those radio devices may be excluded for which synchronization information conveyed by the transmitted synchronization signal is deemed to be not useful, e.g., because the radio is synchronized to a synchronization source which has the same or higher priority as that of the transmitting radio device.

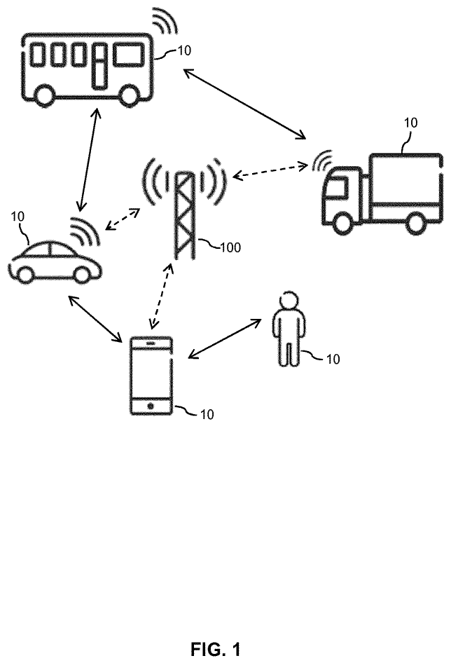

FIG. 1 illustrates an exemplary scenario involving V2X communications. In particular, FIG. 1 shows various UEs 10, which may engage in V2X communication or other D2D communication, illustrated by solid arrows. Further, FIG. 1 shows an access node 100 of a wireless communication network, e.g., an eNB of the LTE technology or a gNB of the NR technology, or an access point of a WLAN (Wireless Local Area Network). At least some of the UEs 10 may also be capable of communicating by using DL radio transmissions and/or UL radio transmissions, illustrated by broken arrows.

The UEs illustrated in FIG. 1 comprise vehicles, a mobile phone, and a person, e.g., a pedestrian, a cyclist, a driver of a vehicle, or a passenger of a vehicle. Here, it is noted that in the case of the vehicles the radio transmissions may be performed by a communication module installed in the vehicle, and that in the case of the person the radio transmissions may be performed by a radio device carried or worn by the person, e.g., a wristband device or similar wearable device. Furthermore, it is noted that the UEs shown in FIG. 1 are merely exemplary and that in the illustrated concepts other types of V2X communication device or D2D communication device could be utilized as well, e.g., RSUs (roadside units) or other infrastructure based V2X communication devices, V2X communication devices based in an aircraft, like an airplane, helicopter, drone, in a spacecraft, in a train or car of a train, in a ship, in a motorcycles, in a bicycle, in a mobility scooter, or in any other kind of mobility or transportation device.

The involved communication entities, i.e., the UEs 10, may be equipped with multiple transmit and receive antennas in order to enable V2X communications using beamformed transmissions. Accordingly, the V2X communication from a certain UE 10 may utilize multiple beams corresponding to different spatial directions. A beamforming mechanism of the UEs 10 may for example be based on an adaptive phased array beamforming technique or on a switched beam beamforming technique.

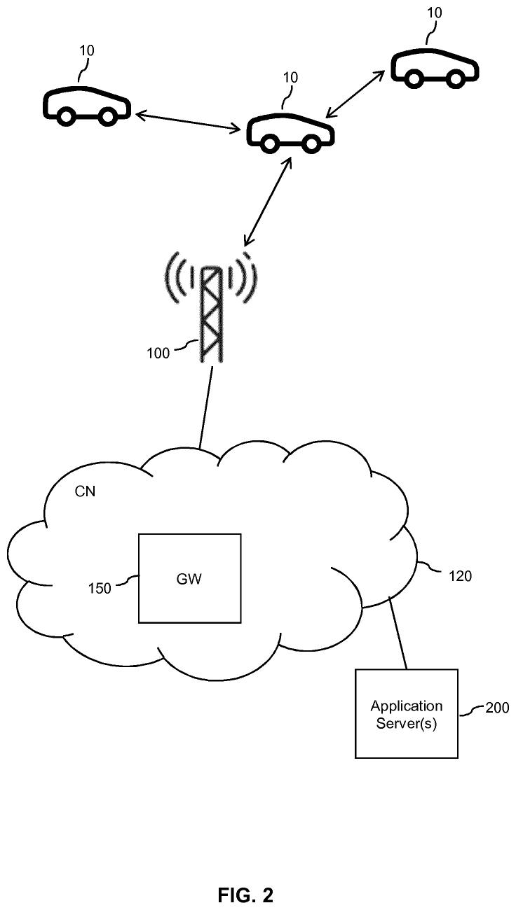

FIG. 2 illustrates an exemplary D2D communication scenario. In particular, FIG. 2 shows multiple UEs 10, which are connected to each other by radio links (illustrated by double-headed arrows). Further, one of the UEs 10 is connected by a radio link to an access node 100 of a wireless communication network, e.g., to an eNB of the LTE technology, or a gNB of the NR technology.

The radio links may be used for D2D communication between the UEs 10. Further, the radio link to the wireless communication network 120 may be used for controlling or otherwise assisting the D2D communication. Further, the D2D communication and/or data communication with the wireless communication network 120 may be used for providing various kinds of services to the UEs 10, e.g., a voice service, a multimedia service, a data service, and/or an intelligent transportation system (ITS) or similar vehicular management or coordination service. Such services may be based on applications which are executed on the UE 10 and/or on a device linked to the UE 10. Further, FIG. 2 illustrates an application service platform 150 in a core network (CN) 120 of the wireless communication network. Further, FIG. 2 illustrates one or more application servers 200 provided outside the wireless communication network. The application(s) executed on the UE 10 and/or on one or more other devices linked to the UE 10 may use the radio links with one or more other UEs 10, the application service platform 150, and/or the application server(s) 200, thereby enabling the corresponding service(s) on the UE 10.

In the example of FIG. 2, the UEs 10 are assumed to be vehicles or vehicle-based communication devices, e.g., a vehicle-mounted or vehicle-integrated communication module, or a smartphone or other user device linked to vehicle systems. However, it is noted that other types of UE could be used as well, e.g., a device carried by a pedestrian, or an infrastructure-based device, such as a roadside unit, e.g., like for example illustrated in FIG. 1.

As outlined above, in the illustrated concepts a transmitting UE 10, in the following also referred to as TX UE 10, may transmit its synchronization signal to only a subset of the potential receiving UEs, in the following also referred to as RX UEs 10, in range. Accordingly, some of the potential RX UEs 10 may be excluded as transmission targets. This may be accomplished by controlling a beamforming configuration applied for transmission of the synchronization signal. Specifically, the beamforming configuration may define multiple beams from the TX UE 10, and the beamforming configuration may be controlled in such a way that one or more of the beams, which are directed towards a RX UE 10 to be excluded, are deactivated or at least assigned a lower transmit power.

The selection of the RX UEs 10 to be excluded as transmission targets may be based on considering synchronization sources of the RX UEs 10, in particular considering a priority of the synchronization sources. Here, it is noted that the UEs 10 may utilize different types of synchronization sources and that these different types of synchronization sources may have different priorities. A first type of synchronization source may be an access node of the wireless communication network, e.g., an eNB or gNB, such as the above-mentioned access node 100. A second type of synchronization source may be another UE 10 which is directly synchronized to an access node of the wireless communication network, e.g., an eNB or gNB, such as the above-mentioned access node 100. Here, directly synchronized means that the synchronization is based on a synchronization signal which the other UE 10 receives from the access node. A third type of synchronization source may be another UE 10 which is indirectly synchronized to an access node of the wireless communication network, e.g., an eNB or gNB, such as the above-mentioned access node 100. Here, indirectly synchronized means that the synchronization is based on a synchronization signal which the other UE 10 receives from a still further UE 10 that is directly or even indirectly synchronized to the access node. A fourth type of synchronization source may be a GNSS. A fifth type of synchronization source may be another UE 10 which is directly synchronized to a GNSS. Here, directly synchronized means that the synchronization is based on a synchronization signal which the other UE 10 receives from the GNSS. A sixth type of synchronization source may be another UE 10 which is indirectly synchronized to a GNSS. Here, indirectly synchronized means that the synchronization is based on a synchronization signal which the other UE 10 receives from a still further UE 10 that is directly or even indirectly synchronized to the GNSS. A seventh type of synchronization source may be any UE 10, which is not synchronized to any external synchronization source (a SyncRef UE). The latter case may include using the respective UE's 10 own internal clock as synchronization source.

For the above types of synchronization sources, the first type may be assigned a first priority P0, the second type may be assigned a second priority P1, the third type may be assigned a third priority P2, the fourth type may be assigned a fourth priority P3, the fifth type may be assigned a fifth priority P4, the sixth type may be assigned a sixth priority P5, and the seventh type may be assigned a seventh priority P6, with the first priority being higher than the second priority, the second priority being higher than the third priority, the third priority being higher than the fourth priority, the fourth priority being higher than the fifth priority, the fifth priority being higher than the sixth priority, and the sixth priority being higher than the seventh priority i.e., P0>P1>P2>P3>P4>P5>P6. It is noted that in some scenarios only a subset of these types of synchronization sources could be used. For example, in a scenario without network coverage the first type, second type and third type could be omitted. Still further, other types of synchronization sources could be considered as well. As can be seen, the types of synchronization sources and associated priorities may correspond to those as described in 3GPP TR 38.885 V16.0.0 (2019-03).

If the synchronization source of a potential RX UE 10 has the same or higher priority as the synchronization source of the TX 10, the TX UE 10 may exclude this RX UE 10 as a transmission target of the synchronization signal. For example, if the TX UE 10 and the potential RX UE 10 are directly synchronized to the same access node or to different access nodes of the wireless communication network, their synchronization sources would have the same priority (P0), and the TX UE 10 could exclude the RX UE 10 as transmission target of the synchronization signal, assuming that there is a high likelihood that the synchronization signal from the TX UE 10 will not be useful to the RX UE 10 and rather increases interference experienced by the RX UE 10. In another example, the TX UE 10 could be directly or indirectly synchronized to an access node of the wireless communication network while the RX UE 10 is synchronized to another UE 10 acting as SyncRef UE. In this case, the synchronization source of the RX UE 10 would have the a lower priority (P6) than the synchronization source of the TX UE 10 (P0 or P1), and the TX UE 10 may decide to keep the RX UE 10 as transmission target of the synchronization signal, assuming that there is a high likelihood that the synchronization signal from the TX UE 10 is useful to the RX UE 10 by enabling it to synchronize to a higher priority synchronization source.

The TX UE 10 may obtain information on the synchronization source from a synchronization signal transmitted by the RX UE 10, e.g., from an initial exchange of synchronization signals transmitted in a broadcast mode. The synchronization signal initially transmitted by the RX UE 10 may for example indicate its own priority, i.e., as which type of synchronization source the RX UE 10 acts when using its synchronization signal. Alternatively or in addition, the synchronization signal could indicate a priority of the synchronization source currently used by the UE 10.

In some scenarios, a collision of the initially exchanged synchronization signals could occur, e.g., due to the synchronization signals being transmitted by UEs which are asynchronous, i.e., not synchronized to the same synchronization source. In the case of such collision, the involved UEs may re-attempt sending their synchronization signals in the broadcast mode, e.g., in the next pre-configured synchronization period.

The selection of the RX UEs 10 to be excluded as transmission targets may further be based on considering signal strengths of synchronization signals, e.g., in terms of a RSRP. For example, the TX UE 10 could compare a signal strength of the synchronization signal from the RX UE 10 to a signal strength of the synchronization signal from the TX UE's 10 own synchronization source. If the synchronization signal from the TX UE 10 has the same priority as the synchronization signal from the RX UE 10 and the signal strength of the synchronization signal from the RX UE 10 is higher than the signal strength of the synchronization signal from the TX UE's 10 synchronization source, the TX UE 10 may decide to not transmit its synchronization signal in the direction of this RX UE 10, because there is a high likelihood that the synchronization signal from the RX UE 10 will be dominant in that direction. Otherwise, if the signal strength of the synchronization signal from the RX UE 10 is lower than the signal strength of the synchronization signal from the TX UE's 10 synchronization source, the TX UE 10 may still transmit its synchronization signal in the direction of the RX UE 10.

Further, the TX UE 10 can also decide to still transmit its synchronization signal in the direction of the RX UE 10, if the RX UE 10 is already synchronized or expected to be synchronized to the same synchronization source as the TX UE 10, so that the synchronization signal from the TX UE 10 will not cause extra interference at the RX UE 10.

It is noted that the above exclusion of transmission targets or beams may be performed in a symmetric or reciprocal fashion also by the RX UE 10. Accordingly, each UE 10 may operate in a similar fashion and exclude other UEs 10 as transmission targets of its synchronization signal, using previously received synchronization signals as a basis for the exclusion selection. The synchronization signals transmitted by the UEs 10 may include an identifier of the beam(s) utilized for transmitting the synchronization signal. For example, in the NR technology the S-SSB includes a PSBCH (Physical Sidelink Broadcast Channel), and the PSBCH could include a field identifying the utilized beam(s). The identifier or field may include six bits, allowing to distinguish up to 64 beams. In this way, beamforming it is possible to utilize configurations with eight beams as for example currently supported in the NR technology but also future enhancements with higher beam numbers. Knowledge about the beams utilized for transmission of a received synchronization signal may enable the TX UE 10 to exclude beams in a corresponding manner when transmitting its own synchronization signal.

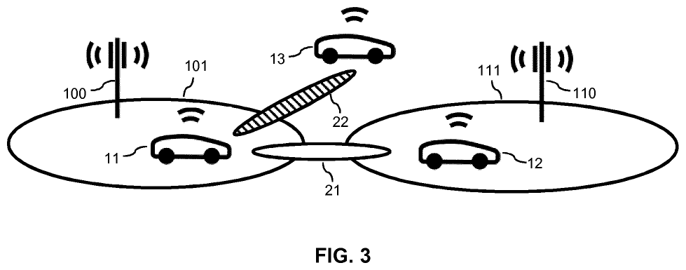

FIG. 3 shows an exemplary scenario for further illustrating the concepts as outlined above. The scenario of FIG. 3 involves a first UE 11, a second UE 12, and a third UE 13. The UEs 11, 12, 13 may for example correspond to any of the above-mentioned UEs 10. As illustrated, the UE 11 is located in a coverage region 101 of access node 100. The UE 12 is located in a coverage region 111 of another access node 110. The access node 100 is assumed to be the synchronization source of the UE 11, and the access node 110 is assumed to be the synchronization source of the UE 12. The UE 13 is assumed to be out of coverage and not synchronized to any external synchronization source and to utilize its internal clock.

In the example of FIG. 3, the UE 11 has configured multiple beams for transmitting its synchronization signal. By way of example, FIG. 3 illustrates a first beam 21 directed from the UE 11 towards the UE 12, and a second beam 22 directed from the UE 11 towards the UE 13. Since the UE 11 and the UE 12 are synchronized to synchronization sources having the same priority (both are synchronized to access nodes), the UE 11 excludes the beam 21 directed towards the UE 12 when transmitting its synchronization signal. In this way, it can be taken into account that the synchronization signal from the UE 11 is not useful for the UE 12 and interference at the UE 12 can be avoided. On the other hand, the UE 11 utilizes the beam 22 towards the UE 13 when transmitting its synchronization signal, because the synchronization source of the UE 13 has a lower priority than the synchronization source of the UE 11 (the UE 13 is not synchronized to any external synchronization source and uses its internal clock only). The UE 13 may thus benefit from reception of the synchronization signal from the UE 11 by being enabled to synchronize to a higher priority synchronization source.

The exclusion of the beam 21 in transmission of the synchronization signal by the UE 11 may be accomplished as follows: Initially, the UE 11 may send a synchronization signal also towards the UE 12, e.g., also using the beam 21 or using a broadcast transmission mode. The UE 12 may receive the initial synchronization signal from the UE 11 and evaluate information indicated by it, e.g., information concerning priority of the synchronization signal from the UE 11. Based on this information, the UE 12 may decide that the synchronization signal from the UE 11 is not useful to the UE 12. Further, the UE 12 will also initially send a synchronization signal to the UE 11. The UE 11 may receive the initial synchronization signal from the UE 12 and evaluate information indicated by it, e.g., information concerning priority of the synchronization signal from the UE 12. Based on this information, the UE 11 may decide that the synchronization signal from the UE 12 is not useful to the UE 11. Further, the UE 11 may decide to exclude the beam 21 when transmitting its synchronization signal in the next synchronization period. In a similar manner, the UE 12 may decide to exclude the beam 21 when transmitting its synchronization signal in the next synchronization period. Further, the UE 13 may decide to exclude the beam 22 when transmitting its synchronization signal in the next synchronization period, because from the perspective of the UE 13 the priority of the synchronization source of the UE 11 is higher than the priority of its own synchronization source.

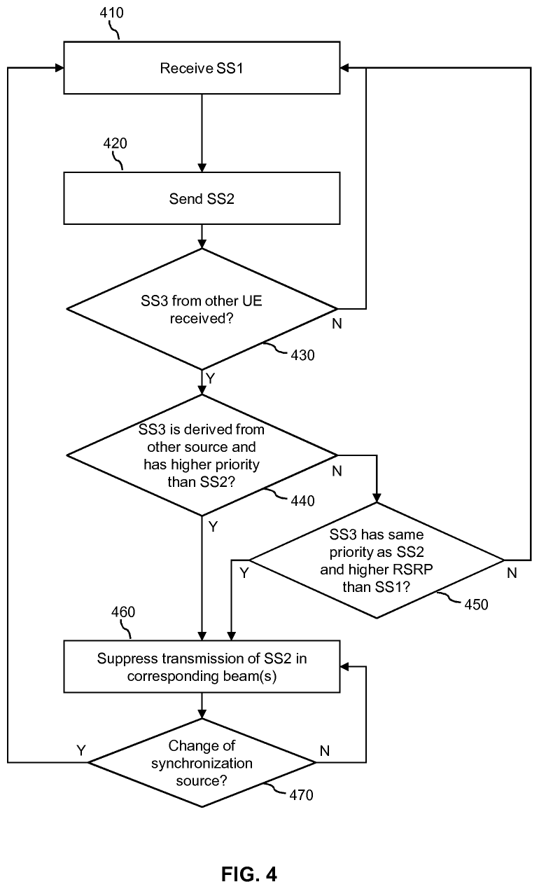

FIG. 4 shows a flowchart for illustrating a procedure to implement the illustrated concepts at a TX UE 10, e.g., the UE 11 in the scenario of FIG. 3.

At block 410, the TX UE 10 may receive a synchronization signal (SS1) from its synchronization source, e.g., from the access node 100 of FIG. 3.

At block 420, the TX UE 10 sends its synchronization signal (SS2). The TX UE 10 may send the synchronization signal SS2 in a broadcast mode, e.g., by sending it on all available beams.

At block 430 the TX UE 10 check whether it received a synchronization signal (denoted SS3) from other UEs 10 in range. If this is not the case, the procedure returns to block 410, as indicated by branch “N”. If a synchronization signals was received, the procedure proceeds to block 440, as indicated by branch “Y”.

Sending the synchronization signal at block 420 and receiving the synchronization signal SS3 at block 430 may be performed in a first synchronization period. Here, it is noted that the TX UE 10 does not need to receive the synchronization signal SS1 in each synchronization period, but may also utilize stored synchronization information and an internal reference derived from the synchronization signal SS1.

At block 440, the TX UE 10 checks if the synchronization signal received from the other UE 10, i.e., the synchronization signal SS3, is derived from a synchronization source which is different from the synchronization source of the TX UE 10 and if the received synchronization signal SS3 has a higher priority than the synchronization signal SS2. If the priority of the received synchronization signal is higher, the procedure may proceed to block 460, as indicated by branch “Y”. Otherwise, the TX UE 10 may proceed to block 450 to further check if the synchronization signal SS3 has the same priority as the synchronization signal SS2 and the synchronization signal SS3 has a higher signal strength, e.g., in terms of RSRP, than the synchronization signal SS1. If this is not the case, the procedure may return to block 410, as indicated by branch “N”. Otherwise, the procedure may proceed to block 460, as indicated by branch “Y”.

At block 460, the TX UE 10 excludes the UE 10 from which the synchronization signal SS3 was received as transmission target of its synchronization signal SS2. This is accomplished by suppressing the transmission of the synchronization signal SS2 on those beams which are directed towards the other UE 10. In a next synchronization period, the TX UE 10 thus transmits its synchronization signal SS2 on a subset of the available beams.

At block 470, the TX UE 10 may check if there was a change with respect to its synchronization source, in particular with respect to the priority of its synchronization source. Such change could for example be due to the TX UE 10 changing to another synchronization source, or due to the synchronization source of the UE 10 switching to another synchronization source. If this is not the case, the procedure may return to block 460 to continue the transmission of the synchronization signal on the subset of beams, as indicated by branch “N”. If there was a change with respect to the synchronization source, the exclusion of the other UE 10 as transmission target of the synchronization signal may be released and the procedure return to block 410, as indicated by branch “Y”. Alternatively or in addition, block 470 could also involve checking a mobility state of the TX UE 10 and triggering the release of the exclusion of the other UE 10 as transmission target of the synchronization signal based on the mobility state of the TX UE 10, e.g., in response to a change of the device no longer being stationary, or in response to an increased rate or probability of device movements.

It is noted that procedures as explained with respect to blocks 430, 440, 450, 460, and 470 may be performed with respect to each other UE 10 in range of the TX UE 10.

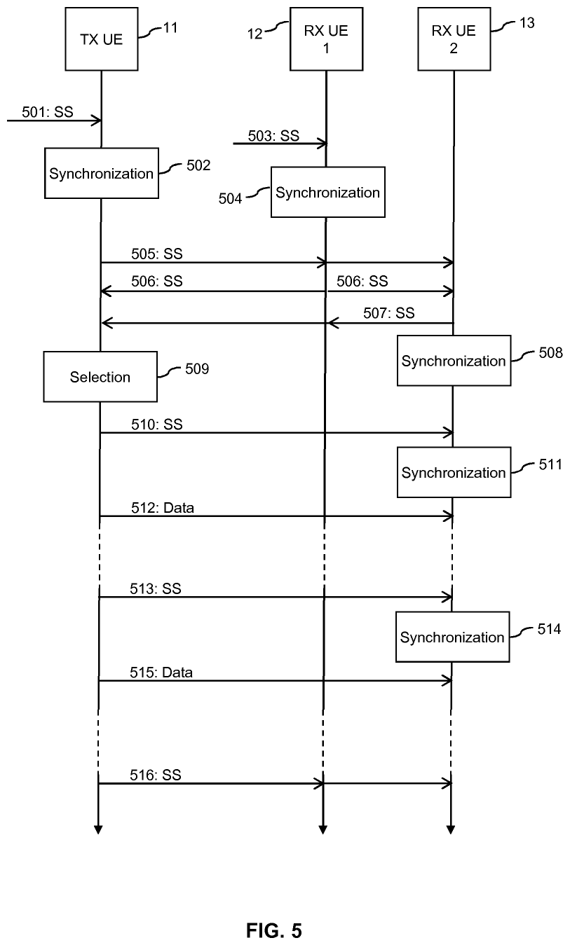

FIG. 5 illustrates exemplary processes which are based on the concepts as outlined above. The processes of FIG. 5 involve the UE 11 acting as TX UE and the UEs 12 and 13 acting as potential RX UEs.

In the processes of FIG. 5, the UE 11 receives a synchronization signal 501. The synchronization signal 501 may originate from an access node of the wireless communication network, e.g., the access node 100 of FIG. 3. At block 502, the UE 11 synchronizes to the synchronization signal 501. Similarly, the UE 12 receives a synchronization signal 503 and synchronizes to the synchronization signal 503 at block 504. The synchronization signal 503 may originate from another access node of the wireless communication network, e.g., the access node 110 of FIG. 3. Like explained in connection with FIG. 3, the processes of FIG. 5 assume that the UE 13 is not synchronized to any external source and uses its internal clock as reference.

The UE 11 then broadcasts a synchronization signal (SS) 505, which is received by the UE 12 and the UE 13. The synchronization signal 505 is derived from the synchronization source of the UE 11. Similarly, the UE 12 broadcasts a synchronization signal 506, which is received by the UE 11 and the UE 13. The synchronization signal 506 is derived from the synchronization source of the UE 12. Further, the UE 13 broadcasts a synchronization signal 507, which is received by the UE 11 and the UE 13. The synchronization signal 507 is derived from the internal clock of the UE 13. The synchronization signals 505, 506, 507 may be transmitted in a first synchronization period. The synchronization signals 505, 506, 507 also provide information on the synchronization sources from which they are derived, e.g., in terms of priority and/or RSRP of the synchronization signal used to derive the respective synchronization signal.

As illustrated by block 508, the UE 13 may then decide to synchronize to one of the received synchronization signals 505, 506, since these have a higher priority than the internal clock of the UE 13. In the illustrated example, it is assumed that the UE 13 synchronizes to the synchronization signal 505, e.g., because it has a higher RSRP than the synchronization signal 506.

At block 509 the UE 11 selects one or more other UEs to exclude as transmission targets in one or more future transmissions of its synchronization signal. In the illustrated example, it is assumed that the UE 11 excludes the UE 12, because it has a synchronization source of the same priority as the UE 11 and the UE 11 received the synchronization signal 506 with a higher RSRP than the RSRP of the synchronization signal 501 as received by the UE 11. On the other hand, the UE 13 is kept as a transmission target because it has a synchronization source of lower priority than the UE 11.

The UE 11 then transmits a synchronization signal 510 in a beamformed transmission suppressing one or more beams that are directed towards the UE 12. As illustrated, the synchronization signal 510 is received by the UE 13, but not by the UE 12. Interference at the UE 12 can thus be reduced. As illustrated by block 511, the UE 13 may utilize the synchronization signal 510 to update its synchronization. Based on the synchronization, the UE 11 and the UE 13 may establish a D2D communication link for transmitting data, as illustrated by exemplary data transmission 512. Here it is noted that establishment of a D2D communication link and transmission of data is of course also possible between the UE 11 and the UE 12, then using the respective synchronization sources of the UE 11 and the UE 13. The synchronization of the UEs 11, 12, 13 may in particular be used for controlling timing of D2D communication on the D2D communication link, e.g., by coordination transmit and receive processes.

As further illustrated, the beamformed transmission of a synchronization signal 513, updating of synchronization 514, and transmission of data 515 may be repeated in one or more subsequent synchronization periods.

As further illustrated, the UE 11 may temporarily return to broadcasting a synchronization signal 516, which is again received by both the UE 12 and the UE 13. Such return to transmission of the synchronization signal in the broadcast mode may be triggered at regular time intervals or by certain events, e.g., a change in mobility status of the UE 11 or a change with respect to the synchronization source of the UE 11. In this way, the beamforming pattern applied for transmission of the synchronization signal may be adapted from time to time and previously suppressed beams reactivated or other beams suppressed.

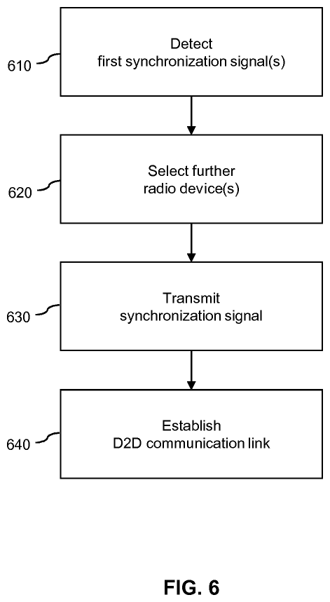

FIG. 6 shows a flowchart for illustrating a method, which may be utilized for implementing the illustrated concepts. The method of FIG. 10 may be used for implementing the illustrated concepts in a radio communication device, e.g., corresponding to any of the above-mentioned UEs 10, 11, 12, 13.

If a processor-based implementation of the radio device is used, at least some of the steps of the method of FIG. 6 may be performed and/or controlled by one or more processors of the radio device. Such radio device may also include a memory storing program code for implementing at least some of the below described functionalities or steps of the method of FIG. 6.

At step 610, the radio device detects at least one first synchronization signal from one or more further radio devices. The at least one first synchronization signal and the second synchronization signal may be transmitted during pre-configured synchronization periods. The synchronization signals may be D2D or sidelink synchronization signals (SLSS), e.g., SLSS of the LTE technology or S-SSBs or the NR technology. In response to a failure to detect the at least one first synchronization signal, the radio device may re-attempt to detect the at least one first synchronization signal.

At step 620, the radio device selects at least one of the one or more further radio devices. This selection is accomplished depending on the at least one detected first synchronization signal.

In some scenarios, the radio device may determine a synchronization source of the respective further radio device transmitting the first synchronization signal. This may be accomplished based on the at least one first synchronization signal received from the respective further radio device. The radio device may then select the at least one further radio device based on the synchronization source of the further radio device. For example, the radio device may select the at least one further radio device based on a comparison of the synchronization source of the further radio device to a synchronization source of the radio device. In some cases, the radio device may select the at least one further radio device in response to synchronization source of the further radio device being different from the synchronization source of the radio device.

In some scenarios, the radio device may determine a priority of the at least one first synchronization signal. This priority may correspond to or be indicative of a priority of the synchronization source of the respective further radio device transmitting the first synchronization signal. The radio device may then select the at least one further radio device based on the priority of the at least one first synchronization signal. For example, the radio device may select the at least one further radio device based on a comparison of the priority of the at least one first synchronization signal to a priority of the second synchronization signal, e.g., in response to the priority of the at least one first synchronization signal being equal to or higher than the priority of the second synchronization signal.

In some scenarios, the radio device may determine a received signal strength of the at least one first synchronization signal. The radio device may then select the at least one further radio device based on the received signal strength of the at least one first synchronization signal. For example, the radio device may select the at least one further radio device based on a comparison of the received signal strength of the at least one first synchronization signal to a received signal strength of a third synchronization signal from a synchronization source of the radio device, e.g., in response to the received signal strength of the at least one first synchronization signal being higher than the received signal strength of the third synchronization signal. In particular, the radio device may select the at least one further radio device in response to a priority of the at least one first synchronization signal being equal to a priority of the second synchronization signal and the received signal strength of the at least one first synchronization signal being lower than the received signal strength of the third synchronization signal. The signal strengths of the first synchronization signal and the third synchronization signal may for example be represented in terms of RSRPs.

At step 630, the radio device transmits a second synchronization signal. In this transmission, the selected at least one further radio device is excluded as a transmission target of the second synchronization signal. This may involve that the radio device selects at least one beam from multiple beams for transmission of the second synchronization signal. The selected at least one beam may corresponding to a direction from the radio device to the selected at least one of the further radio device, in particular to a direction from which the first synchronization signal is received. The radio device may then suppress transmission of the second synchronization signal on the selected at least one beam. Accordingly, while transmitting the synchronization signal on the other, non-selected beams, transmission of the synchronization signal on the selected beams may be suppressed or precluded.

In some scenarios the radio device may intermittently transmitting the second synchronization signal to also to the selected at least one further radio device. In other words, the exclusion of the selected at least one further radio device as transmission target may be temporarily suspended. A rate of intermittently transmitting the second synchronization signal also to the selected at least one further radio device may for example depend on mobility of the radio device, e.g., on include velocity, on whether the device is stationary or not, or on probability of device movements. The intermittent transmission of the second synchronization signal to also to the selected at least one further radio device may thus be controlled to occur more often if the radio device has a higher velocity, starts moving after being stationary, or has a higher probability of movements.

At step 640, the radio device may establish a D2D communication link with at least one of the one or more further radio devices. Based on the at least one first synchronization signal and/or the second synchronization signal the radio device may control timing of D2D communication on the at least one D2D communication link.

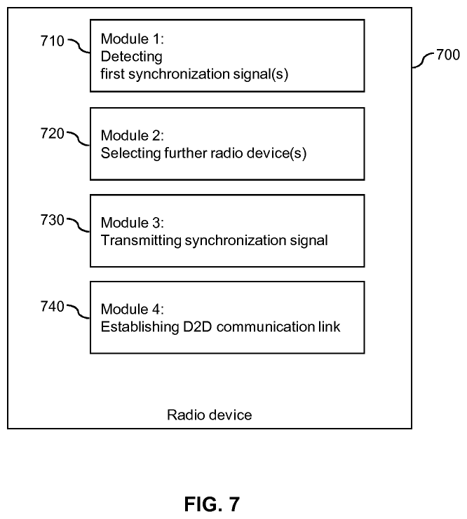

FIG. 7 shows a block diagram for illustrating functionalities of a radio device 700 which operates according to the method of FIG. 6. The radio device 700 may for example correspond to any of the above-mentioned UEs 10, 11, 12, 13. As illustrated, the radio device 700 may be provided with a module 710 configured to detect at least one first synchronization signal, such as explained in connection with step 610. Further, the radio device 700 device may be provided with a module 720 configured to select one or more further radio devices, such as explained in connection with step 620. Further, the radio device 700 may be provided with a module 730 configured to transmit a second synchronization signal, such as explained in connection with step 630. Further, the radio device 700 may be provided with a module 740 configured to establish a D2D communication link, such as explained in connection with step 640.

It is noted that the radio device 700 may include further modules for implementing other functionalities, such as known functionalities of a UE in the LTE and/or NR radio technology. Further, it is noted that the modules of the radio device 700 do not necessarily represent a hardware structure of the radio device 700, but may also correspond to functional elements, e.g., implemented by hardware, software, or a combination thereof.

It is noted that the illustrated concepts could also be implemented in a system including multiple radio devices, in particular at least one first radio device operating according to the method of FIG. 6 and one or more of the further radio devices transmitting the first synchronization signal(s).

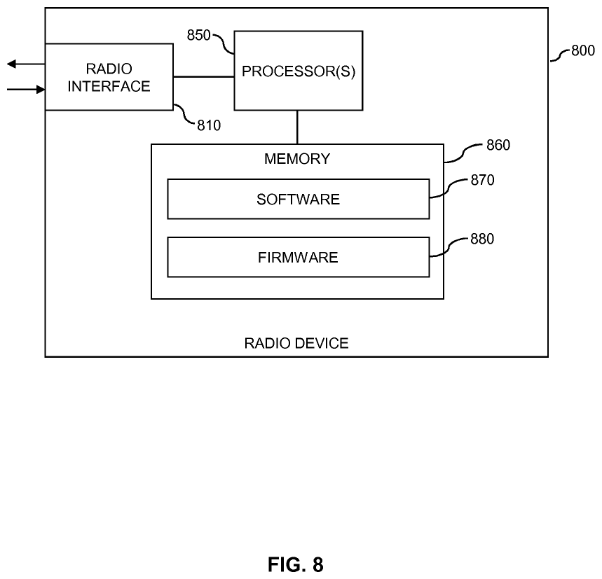

FIG. 8 illustrates a processor-based implementation of a radio device 800 which may be used for implementing the above-described concepts. For example, the structures as illustrated in FIG. 8 may be used for implementing the concepts in any of the above-mentioned UEs 10, 11, 12, 13.

As illustrated, the radio device 800 includes one or more radio interfaces 810. The radio interface(s) 810 may for example be based on the LTE technology or the NR technology.

Further, the radio device 800 may include one or more processors 850 coupled to the radio interface(s) 810 and a memory 860 coupled to the processor(s) 850. By way of example, the radio interface(s) 810, the processor(s) 850, and the memory 860 could be coupled by one or more internal bus systems of the radio device 800. The memory 860 may include a Read-Only-Memory (ROM), e.g., a flash ROM, a Random Access Memory (RAM), e.g., a Dynamic RAM (DRAM) or Static RAM (SRAM), a mass storage, e.g., a hard disk or solid state disk, or the like. As illustrated, the memory 860 may include software 870 and/or firmware 880. The memory 860 may include suitably configured program code to be executed by the processor(s) 850 so as to implement the above-described functionalities for controlling D2D communication, such as explained in connection with FIGS. 6 and 7.

It is to be understood that the structures as illustrated in FIG. 8 are merely schematic and that the radio device 800 may actually include further components which, for the sake of clarity, have not been illustrated, e.g., further interfaces or processors. Also, it is to be understood that the memory 860 may include further program code for implementing known functionalities of a UE. According to some embodiments, also a computer program may be provided for implementing functionalities of the radio device 800, e.g., in the form of a physical medium storing the program code and/or other data to be stored in the memory 860 or by making the program code available for download or by streaming.

As can be seen, the concepts as described above may be used for efficiently controlling synchronization procedures in D2D communication. More specifically, the illustrated concepts may be used for mitigating or reducing interference caused by synchronization signals, by suppressing or precluding transmission of a synchronization signal towards a UE for which the synchronization signal is probably not useful. Further, reducing the number of beams utilized for transmission of the synchronization signal may also allow for reducing energy consumption of the UE transmitting the synchronization signal and/or for increasing transmission power of the synchronization signal on other beams. Increasing the transmission power of the synchronization signal on the other beams may in turn allow for obtaining a higher transmission range and/or better signal quality at potential recipients of the synchronization signal. These effects are particularly beneficial in situations where several UEs within range of each other are under different synchronization sources of the same priority.

It is to be understood that the examples and embodiments as explained above are merely illustrative and susceptible to various modifications. For example, the illustrated concepts may be applied in connection with various kinds of radio technologies, without limitation to the LTE technology or NR technology. Further, the concepts may be applied with respect to various types of UEs, without limitation to vehicle-based UEs. Further, the concepts may be applied using various types of beamforming technologies to suppress or preclude certain beams. Moreover, it is to be understood that the above concepts may be implemented by using correspondingly designed software to be executed by one or more processors of an existing device or apparatus, or by using dedicated device hardware. Further, it should be noted that the illustrated apparatuses or devices may each be implemented as a single device or as a system of multiple interacting devices or modules.

1-21. (canceled)

22. A method of controlling device-to-device communication, the method comprising:
a radio device detecting at least one first synchronization signal from one or more further radio devices;
depending on the at least one detected first synchronization signal, the radio device selecting at least one of the one or more further radio devices; and
the radio device transmitting a second synchronization signal, excluding the selected at least one further radio device as a transmission target of the second synchronization signal.

23. The method of claim 22, comprising:
the radio device selecting at least one beam from multiple beams for transmission of the second synchronization signal, the selected at least one beam corresponding to a direction from the radio device to the selected at least one of the further radio device; and
the radio device suppressing transmission of the second synchronization signal on the selected at least one beam.

24. The method of claim 22, comprising:
based on the at least one first synchronization signal, the radio device determining a synchronization source of the respective further radio device transmitting the first synchronization signal; and
the radio device selecting the at least one further radio device based on the synchronization source of the further radio device.

25. The method of claim 24, comprising:
the radio device selecting the at least one further radio device based on a comparison of the synchronization source of the further radio device to a synchronization source of the radio device.

26. The method of claim 25, comprising:
the radio device selecting the at least one further radio device in response to synchronization source of the further radio device being different from the synchronization source of the radio device.

27. The method of claim 22, comprising:
the radio device determining a priority of the at least one first synchronization signal; and
the radio device selecting the at least one further radio device based on the priority of the at least one first synchronization signal.

28. The method of claim 27, comprising:
the radio device selecting the at least one further radio device based on a comparison of the priority of the at least one first synchronization signal to a priority of the second synchronization signal.

29. The method of claim 28, comprising:
the radio device selecting the at least one further radio device in response to the priority of the at least one first synchronization signal being equal to or higher than the priority of the second synchronization signal.

30. The method of claim 22, comprising:
the radio device determining a received signal strength of the at least one first synchronization signal; and
the radio device selecting the at least one further radio device based on the received signal strength of the at least one first synchronization signal.

31. The method of claim 30, comprising:
the radio device selecting the at least one further radio device based on a comparison of the received signal strength of the at least one first synchronization signal to a received signal strength of a third synchronization signal from a synchronization source of the radio device.

32. The method of claim 31, comprising:
the radio device selecting the at least one of the one or more further radio devices in response to the received signal strength of the at least one first synchronization signal being higher than the received signal strength of the third synchronization signal.

33. The method of claim 32, comprising:
the radio device selecting the at least one of the one or more further radio devices in response to a priority of the at least one first synchronization signal being equal to a priority of the second synchronization signal and the received signal strength of the at least one first synchronization signal being higher than the received signal strength of the third synchronization signal.

34. The method of claim 22, comprising:
the radio device intermittently transmitting the second synchronization signal to the selected at least one further radio device.

35. The method of claim 34, wherein a rate of said intermittently transmitting the second synchronization signal to the selected at least one further radio device depends on mobility of the radio device.

36. The method of claim 22, comprising:
in response to a failure to detect the at least one first synchronization signal, the radio device re-attempting to detect the at least one first synchronization signal.

37. The method of claim 22, wherein the at least one first synchronization signal and the second synchronization signal are transmitted during pre-configured synchronization periods.

38. The method of claim 22, comprising:
the radio device establishing a device-to-device communication link with at least one of the one or more further radio devices;
based on the at least one first synchronization signal and/or the second synchronization signal, the radio device controlling timing of device-to-device communication on the device-to-device communication link.

39. A radio device, the radio device comprising:
at least one processor, and
a memory containing program code executable by the at least one processor, wherein the program code is configured such that execution by the at least one processor causes the radio device to:
detect at least one first synchronization signal from one or more further radio devices;
select at least one of the one or more further radio devices, in dependence on the at least one detected first synchronization signal; and
transmit a second synchronization signal, excluding the selected at least one further radio device as a transmission target of the second synchronization signal.

40. A non-transitory computer-readable medium comprising, stored thereupon, program code to be executed by at least one processor of a radio device, the program code being configured such that execution of the program code by the at least one processor causes the radio device to:
detect at least one first synchronization signal from one or more further radio devices;
select at least one of the one or more further radio devices, in dependence on the at least one detected first synchronization signal; and
transmit a second synchronization signal, excluding the selected at least one further radio device as a transmission target of the second synchronization signal.
